(19) United States
(12) Patent Application Publication
(10) Pub. No.: US 2013/0141751 A1
(43) Pub. Date: Jun. 6, 2013

(54) IMAGE FORMING APPARATUS WITH ABNORMALITY DETECTING FUNCTION, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Yousuke Hata, Ichikawa-shi (JP)

(73) Assignee: CANON KABUSHIKI KAISHA, Tokyo (JP)

(21) Appl. No.: 13/684,800

(22) Filed: Nov. 26, 2012

(30) Foreign Application Priority Data
Dec. 2, 2011 (JP) 2011-264633

(51) Int. Cl. G06F 3/12

(52) U.S. Cl. CPC G06F 3/12
USPC 358/1.14

(57) ABSTRACT

An image forming apparatus capable of preventing a controlled object from being controlled based on an error signal. An image forming apparatus is provided with one or more processing units for performing processes concerning image formation and a control unit for controlling the processing units by communicating with the processing units via serial communication or parallel communication. A detection unit detects errors in the serial communication. A count unit counts the number of errors detected by the detection unit. A specifying unit specifies cause of the detected errors when the count value showing the number of errors counted by the count unit is not smaller than a predetermined diagnostic threshold value. A general control unit controls the image forming apparatus to operate or stop the image forming apparatus based on the cause specified by the specifying unit.

### BACKGROUND OF THE INVENTION

1. Field of the Invention

The present invention relates to an image forming apparatus having a function for detecting abnormality inside the apparatus, a control method therefor, and a storage medium storing a control program therefor.

2. Description of the Related Art

An image forming apparatus like a laser printer has a plurality of processing units, such as a laser scanner, an image transfer unit, a fixing unit, a sheet conveyance unit, etc. When controlled objects, such as a motor and a high voltage circuit, included in such processing units are controlled by a single controller, large space is occupied by cables between the controller and the respective controlled objects.

In order to solve such a problem, as shown in FIG. 13, for example, a master controller and a plurality of slave controllers connected to the master controller with serial signal lines may be employed. The master controller directly controls a processing unit arranged near the master controller and indirectly controls processing units arranged away from the master controller using the slave controllers arranged near the process units.

According to this method, the control cables are enough for short distance between the slave controllers arranged near the processing units and controlled objects in the processing units. Using serial signal lines between the master controller and the slave controllers, cables can be reduced compared with using parallel signal lines.

In serial communication, a communication error can be easily detected by using a well-known general error detection method, such as an addition of a parity bit to transmission data.

An image forming apparatus in which a plurality of controllers are connected by serial signal lines is disclosed in Japanese Laid-Open Patent Publication (Kokai) No. 2009-128668 (JP 2009-128668A), for example. The apparatus disclosed in the publication retries data transmission/reception operation when a master controller detects an error in the serial communication, which prevents the apparatus from stopping when data is confused by a sudden noise etc.

Further, when the number of communication errors per unit time exceeds a predetermined threshold value, the apparatus disclosed in the publication determines that it is abnormal, stops the operation, and displays an error code on a display panel.

However, there is some possibility of continuing the operation even when abnormality occurs in the apparatus. For example, it is a case where high-voltage current that is inputted into an electrostatic charger leaks to a frame of the apparatus unit for some reason and a leak noise occurs inside the apparatus.

The leak noise that occurs due to the leak of high-voltage current generates noises in the serial communication between the master controller and the slave controller, and in the parallel communication between the controllers and the controlled object.

As mentioned above, since an error can be easily detected in the serial communication, the apparatus is able to continue the operation normally by retrying communication even when an error occurs, when the number of the communication errors does not exceed the threshold value.

On the other hand, since an error cannot be detected in the parallel communication, misdetection of a signal due to noises cannot be recognized as an error, and a controlled object is controlled based on the misdetected signal.

For example, when a noise is superimposed on a signal for indicating a laser writing start position from a laser scanner, an abnormal image in which the writing start position differed from the normal position is outputted.

### SUMMARY OF THE INVENTION

The present invention provides an image forming apparatus, a control method therefor, and a storage medium storing a control program therefor, which are capable of preventing a controlled object from being controlled based on an error signal.

Accordingly, a first aspect of the present invention provides an image forming apparatus that is provided with one or more processing units for performing processes concerning image formation and a control unit for controlling the processing units by communicating with the processing units via serial communication or parallel communication, comprising a detection unit configured to detect errors in the serial communication, a count unit configured to count the number of errors detected by the detection unit, a specifying unit configured to specify cause of the detected errors when the count value showing the number of errors counted by the count unit is not smaller than a predetermined diagnostic threshold value, and a general control unit configured to control the image forming apparatus to operate or stop the image forming apparatus based on the cause specified by the specifying unit.

Further features of the present invention will become apparent from the following description of exemplary embodiments with reference to the attached drawings.

### BRIEF DESCRIPTION OF THE DRAWINGS

FIG. 1 is a view showing a mechanical configuration of an image forming apparatus according to a first embodiment.

FIG. 2 is a block diagram schematically showing an electrical configuration of the image forming apparatus in FIG. 1.

FIG. 3 is a timing chart of serial communication between a master controller and a slave controller that are shown in FIG. 2.

FIG. 4 is a flowchart showing an error detection process of a comparative example.

FIG. 5 is a view showing a state where leak noises occur in serial communication and parallel communication in the comparative example.

FIG. 6 is a view showing communication states and states of an image forming apparatus corresponding to occurrence levels of a leak noise in the comparative example.

FIG. 7 is a view showing the communication states and the states of the image forming apparatus corresponding to the occurrence levels of the leak noise due to leak from a high-voltage circuit shown in FIG. 2.

FIG. 8 is a flowchart showing an error detection process executed by a CPU in FIG. 2.

FIG. 9 is a flowchart showing a self-diagnostic process executed in the step S115 in FIG. 8.

FIG. 10 is a view showing controlled objects and their numbers used in the self-diagnostic process in FIG. 9.

FIG. 11 is a view showing an electrical configuration of an image forming apparatus according to a second embodiment.

FIG. 12 is a flowchart showing an error detection process executed by a CPU in FIG. 11.

FIG. 13 is a view showing an electrical configuration of a conventional image forming apparatus in which a plurality of processing units are controlled by a single controller.

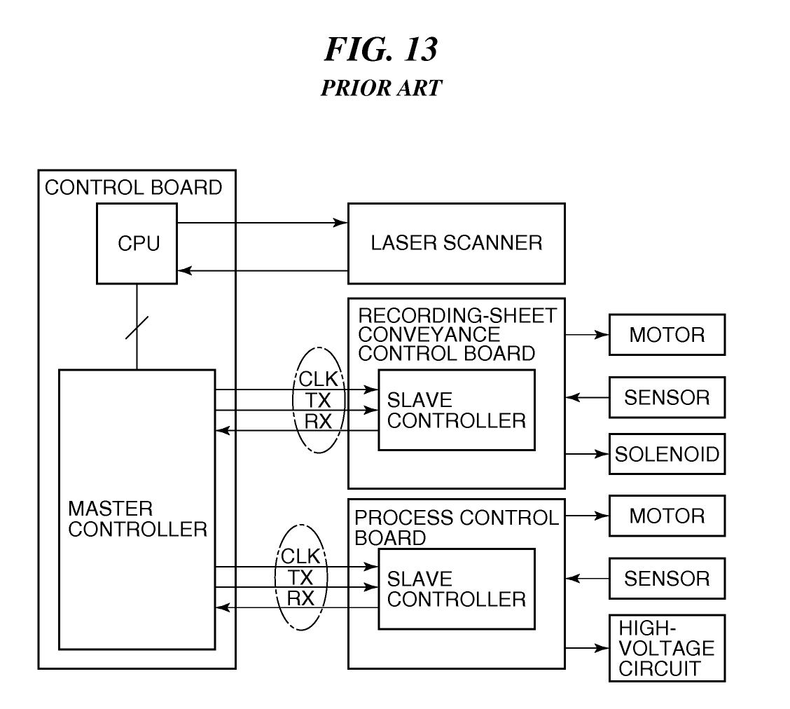

### DESCRIPTION OF THE EMBODIMENTS

Hereafter, embodiments will be described in detail with reference to the drawings.

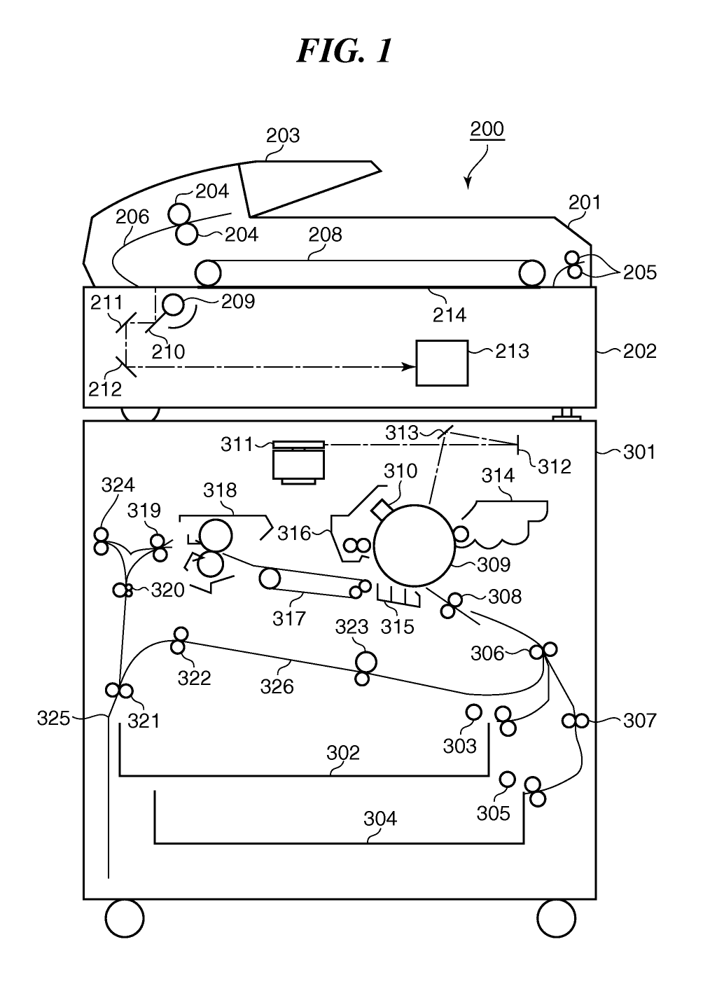

FIG. 1 is a view showing a mechanical configuration of an image forming apparatus 200 according to a first embodiment.

The image forming apparatus 200 shown in FIG. 1 comprises a scanner unit that reads an image of an original and consists of an automatic document feeder 201 and a reading unit 202, and a printing unit 301 that prints the read image onto a recording sheet.

One original put on an original mounting section 203 of the automatic document feeder 201 is separated from other originals and is fed by a feed roller 204, and is conveyed to the reading unit 202 via a conveyance guide 206. The original is conveyed in constant speed with a conveyance belt 208, and is ejected outside the apparatus by an ejecting roller 205.

Reflected light from the original illuminated by an illumination system 209 at a reading position of the reading unit 202 enters into an image reading unit 213 through an optical system that consists of reflective mirrors 210, 211, 212. The image reading unit 213 converts the reflected light into an image signal. The image reading unit 213 consists of a lens, a CCD as a photoelectric conversion element, a drive circuit for the CCD, and so on.

There are two modes for reading an original. One is a moving original reading mode in which an original conveyed is read at the fixed reading position. The other is a stationary original reading mode in which an original fixed on a platen glass 214 of the reading unit 202 is read by moving the illumination system 209 and the reflective mirrors 210, 211, and 212 in a constant speed. Usually, a sheet shaped original is read in the moving original reading mode, and a bound original is read in the stationary original reading mode.

The image signal is processed by an image processing unit (not shown), and then, the processed image signal is printed onto a recording sheet in units of page by the printing unit 301. The printing unit 301 comprises a laser scanner that emits a laser beam modulated according to the image signal, a process unit that transfers a toner image formed on a photosensitive drum 309 by the laser scanner to the recording sheet and fixes it, and a sheet conveyance unit that ejects the recording sheet outside the apparatus through the process unit.

The laser scanner includes a semiconductor laser (not shown) that is driven in response to the image signal, and a polygon mirror 311 that deflects the laser beam emitted from the semiconductor laser. The laser beam deflected by the polygon mirror 311 scans the photosensitive drum 309 of which a surface has been uniformly charged by an electrostatic charger 310 via mirrors 312 and 313, and forms an electrostatic latent image.

The electrostatic latent image is developed with toner of a development device 314, and a toner image is transferred onto the recording sheet by a transferring unit 315. The residual toner that remains on the photosensitive drum 309 after transferring the toner image onto the recording sheet is removed by a cleaner 316.

The recording sheets are stocked in sheet cassettes 302 and 304. The recording sheet stocked in the sheet cassette 302 is fed by a feed roller 303, is conveyed by a pre-registration roller pair 306, and is conveyed to a transfer position by a registration roller pair 308 after adjusting timing.

On the other hand, the recording sheet stocked in the sheet cassette 304 is fed by a feed roller 305, is conveyed by a conveying roller pair 307 and the pre-registration roller pair 306, and is conveyed to the transfer position by the registration roller pair 308 after adjusting timing. The recording sheet onto which the toner image has been transferred is conveyed to a fixing unit 318 by a conveyance belt 317, and the fixing unit 318 fixes the toner image to the recording sheet.

When a single-sided mode is set, the recording sheet from the fixing unit 318 is ejected outside the apparatus by a fixing-ejecting roller pair 319 and an ejecting roller pair 324. When a double-sided mode is set, the recording sheet from the fixing-ejecting roller pair 319 is conveyed to an inversion path 325 by conveying rollers 320 and an inversion roller pair 321. The rotations of the inversion roller pair 321 are reversed immediately after the rear end of the recording sheet passes a confluence with a double-sided path 326, and the recording sheet is reversed and is conveyed to the double-sided path 326. The recording sheet conveyed to the double-sided path is conveyed to a position of a second double-sided roller pair 323 by a first double-sided roller pair 322, and is stopped there.

A horizontal deviation detection sensor (not shown) detects the horizontal position of the recording sheet while stopping. After the detection, the recording sheet is conveyed by the first double-sided roller pair 322 and the second double-sided roller pair 323, is again conveyed by the pre-registration roller pair 306, and is conveyed by the registration roller pair 308 after adjusting timing. And then, the recording sheet onto which the toner image is transferred and fixed is ejected outside the apparatus.

At this time, the writing start position of the laser to the photosensitive drum 309 is adjusted based on the detection result of the horizontal deviation detection sensor. Thereby, the position of the image is adjusted with respect to the recording sheet in the horizontal direction.

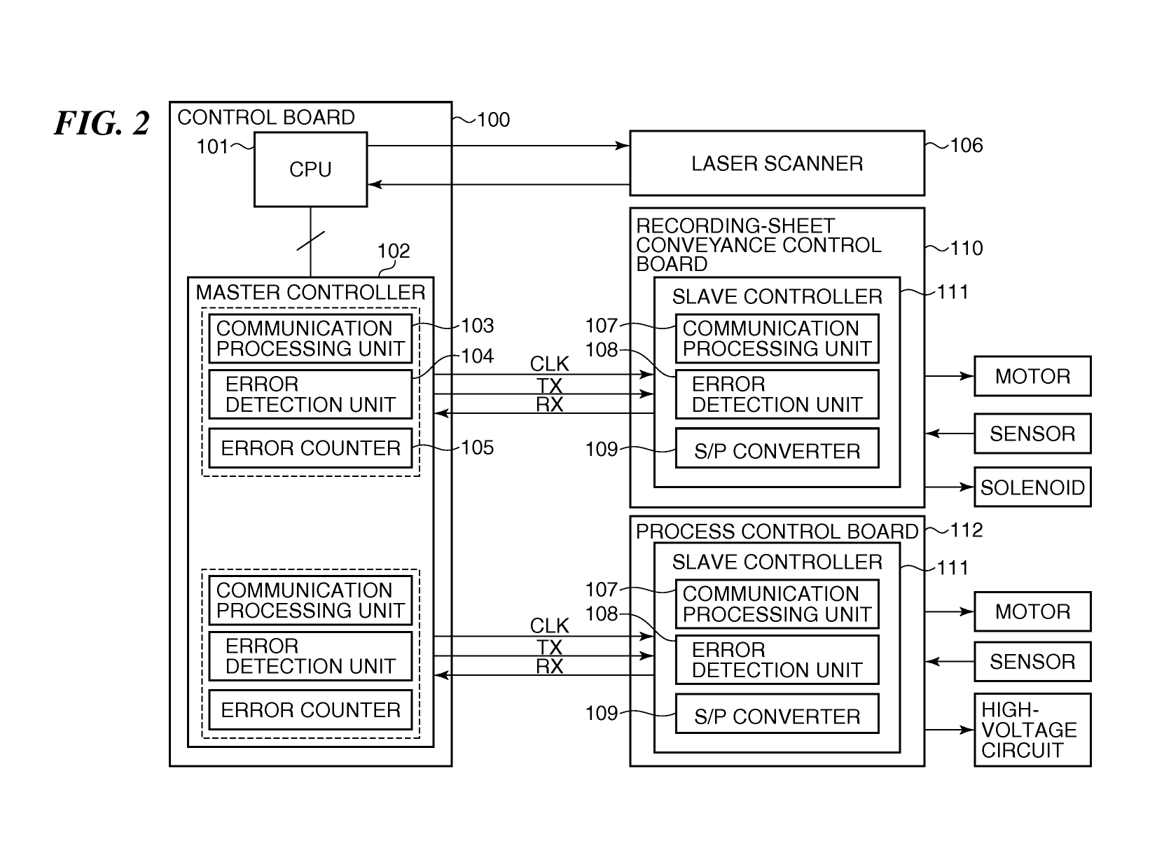

FIG. 2 is a block diagram schematically showing an electrical configuration of the image forming apparatus 200 shown in FIG. 1 according to the first embodiment.

The image forming apparatus 200 is controlled by a CPU 101 provided on a control board 100.

The CPU 101 is connected to a master controller 102, such as an ASIC and an FPGA, through a bus. The master controller 102 has serial connections with slave controllers 111 provided on a recording-sheet conveyance board 110 that controls a recording sheet conveyance unit and a process control board 112 that controls the process unit that forms and fixes an image, respectively. The recording-sheet conveyance board 110 and the process control board 112 are connected with motors, sensors, etc., respectively. The master controller 102 and the slave controller 111 perform serial communication with a three-wire system that uses three kinds of signals including a communication clock signal CLK, send data TX, and receive data RX. The send data TX is transmitted from the master controller 102 to the slave controllers 111, and the receive data RX is transmitted from the slave controllers 111 to the master controller 102. Although the serial communication with the three-wire system is used in this embodiment, another serial communication may be used.

The master controller 102 has communication processing units 103 that perform serial communication, error detection units 104 that detect errors in the serial communication, and error counters 105 that count the number of errors detected by the error detection units 104. The above-mentioned error detection unit 104 corresponds to the detection unit that detects errors in serial communication. The error counter 105 corresponds to the count unit that counts the number of errors in the communication.

Each of the slave controllers 111 has a communication processing unit 107 that performs the serial communication, the error detection unit 108 that detects errors in serial communication, and an S/P converter 109. The S/P converter 109 converts the serial data received from the master controller via the serial communication into a parallel signal for driving controlled objects (a motor, a sensor, a solenoid, etc.).

Since the control board 100 communicates with the recording-sheet conveyance control board 110 and the process control board 112 in the serial communication, the amount of cables can be reduced compared with the case where the control board 100 directly drives the motors, sensors, etc.

Particularly, when the path to the controlled object from the control board 100 is long, the amount of cables can be reduced by arranging the board on which the slave controller is mounted near the controlled object.

When the path from the control board 100 to the controlled objects is short on the other hand, it is more preferable that the control board 100 directly drives the controlled objects without using the serial communication. In this example, since the laser scanner 106 is close to the control board 100, the laser scanner 106 is connected with the control board 100 with the parallel communication, and is directly driven by the CPU 101.

In FIG. 2, the recording-sheet conveyance control board 110 and the process control board 112 correspond to the processing units that perform processes concerning image formation, and the control board 100 corresponds to the control unit that controls the processing units by communicating with the processing units. The control board 100 corresponds to the general control unit that controls the image forming apparatus 200 to operate or stop the image forming apparatus 200. In this embodiment, although the recording-sheet conveyance control board 110 and the process control board 112 are mentioned as examples of the processing unit, the present invention is not limited to these examples. A process concerning image formation is not only limited to an image-formation process and a process for conveying a recording sheet, but corresponds to various kinds of processes concerning image formation.

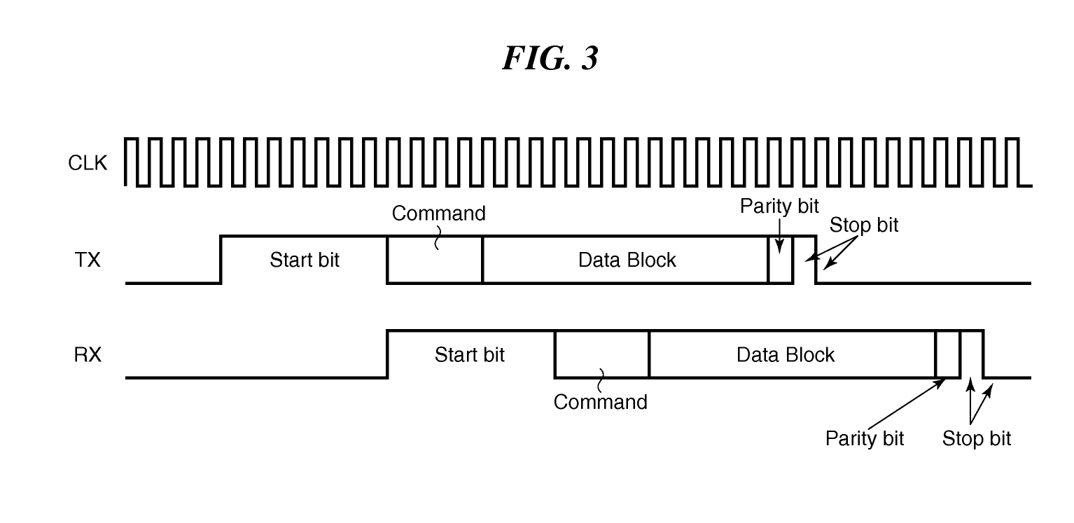

FIG. 3 is a timing chart of serial communication.

In FIG. 3, a communication clock signal CLK used as a reference signal for serial communication that is always transmitted to the slave controllers 111 from the master controller 102, while the master controller 102 is energized.

In this embodiment, the master controller 102 transmits a set of a start bit, a command, a data block, a parity bit, and a stop bit to the slave controller 111 using the send data TX at predetermined intervals. When the master controller 102 does not issue a control instruction to the slave controller, the command and the data block become null data.

On the other hand, when receiving a set of a start bit, a command, a data block, a parity bit, and a stop bit from the master controller 102, the slave controller 111 replies by transmitting a set of a start bit, a command, a data block, a parity bit, and a stop bit to the master controller 102 using the receive data RX. The slave controller 111 returns the processing result corresponding to the control instruction from the master controller 102 using the receive data RX. When the master controller 102 does not issue a control instruction and the command and data block in the send data TX are null data, the command and data block of the receive data RX become null data.

The master controller 102 and the slave controllers 111 are always transmitting and receiving data via the serial communication.

The data communication from the master controller 102 to the slave controller 111 starts by transmitting a start bit onto the send data TX. The start bit is defined as continuous Hi signal during seven clocks in this embodiment. However, the start bit is not limited to the seven clocks as long as they can be distinguished from usual communications data. Receiving the start bit, the slave controller 111 recognizes the start of data transmission, and returns the start bit onto the receive data RX. Accordingly, the transmission of the send data TX and the transmission of the receive data RX are performed in parallel processing. The send data TX is identical to the receive data RX.

After outputting the start bit, the master controller 102 transmits the command and the data block. A command area is used for communicating the commands concerning the serial communication process between the master controller 102 and the slave controller 111.

For example, when the error detection unit 108 of the slave controller 111 detects an error of the data received from the master controller 102, the slave controller 111 notifies the master controller 102 of the error using the command area of the receive data RX.

The data block of the send data TX is an area that the master controller 102 transmits driving signals for controlled objects (a motor etc.) to the slave controller 111. The data block of the receive data RX is an area that the slave controller 111 transmits detected signals from controlled objects (a sensor etc.) to the master controller 102.

The parity bit and the stop bit are transmitted after transmitting the data block. The parity bit is odd parity in this embodiment. By transmitting the parity bit, the error detection unit of the receiving side can detect one-bit data corruption as an error. Although this embodiment employs odd parity, even parity may be employed.

The stop bit is a signal that indicates the end of communication, and is a combination of the Hi signal of one clock and the Lo signal of one clock. The stop bit is not limited to this format in the same manner as the other signals.

An error detection method in the serial communication will be described. Three kinds of communication errors are detected in this embodiment.

The first error is a start error. When a start bit does not return by the receive data RX within a predetermined time after transmitting a start bit by the send data TX, it is determined as the start error. The error detection unit 104 of the master controller 102 detects a start error based on the command, data block, and parity bit of the receive data RX, and increments the error counter 105 when detecting the start error.

The second error is a parity error. Since this employs the odd parity, when the number of the Hi bits in a command, a data block, and a parity bit does not become odd, it is determined as the parity error.

The error detection unit 104 of the master controller 102 detects a parity error based on the command, data block, and parity bit of the receive data RX, and increments the error counter 105 when detecting the parity error.

On the other hand, the error detection unit 108 of the slave controller 111 detects an error based on the data block and parity bit of the send data TX. When an error is detected, the communication processing unit 107 notifies the master controller 102 of the error using the command in the receive data RX. The master controller 102 increments the error counter 105 in response to the error notification by the command in the receive data RX.

The third error is a framing error. When the stop bit is different from a predetermined format, it is determined as the framing error. In this embodiment, when the stop bit is not the combination of the Hi signal of one clock and the Lo signal of one clock, it is determined as the framing error.

Like the above-mentioned parity error, each of the error detection unit 104 of the master controller 102 and the error detection unit 108 of the slave controller 111 detects the framing error, and increments the error counter 105 when detecting the framing error.

Thus, the error detection unit 108 detects an error in the serial communication by using the detection method for the three kinds of communication errors.

According to this error detection method, when an error is detected by a certain communication, data is not updated based on the data received by the communication.

In the communication of this embodiment, the master controller 102 transmits the same command and data block to the slave controller 111 several times. Accordingly, even if an error occurs in a certain communication, the same control signal is receivable by other communications. In this embodiment, even if an error is detected, the communication is not retried.

For example, it is assumed that the error detection unit 108 of the slave controller 111 detects an error in a received send data TX, when the master controller 102 transmits a signal that switches a motor connected to the slave controller 111 to ON from OFF by the send data TX.

At this time, the slave controller 111 discards the received send data TX and does not switch the motor to ON from OFF. Accordingly, the motor is not switched to ON from OFF until normal data will be received without detecting an error. This prevents the data from updating based on erroneous data even if data is confused under the influence of a noise, etc.

On the other hand, when such errors occur continuously, the data is not updated for a long time, the apparatus cannot operate normally. Therefore, when errors occur continuously, it is necessary to determine that it is abnormal and to stop the apparatus.

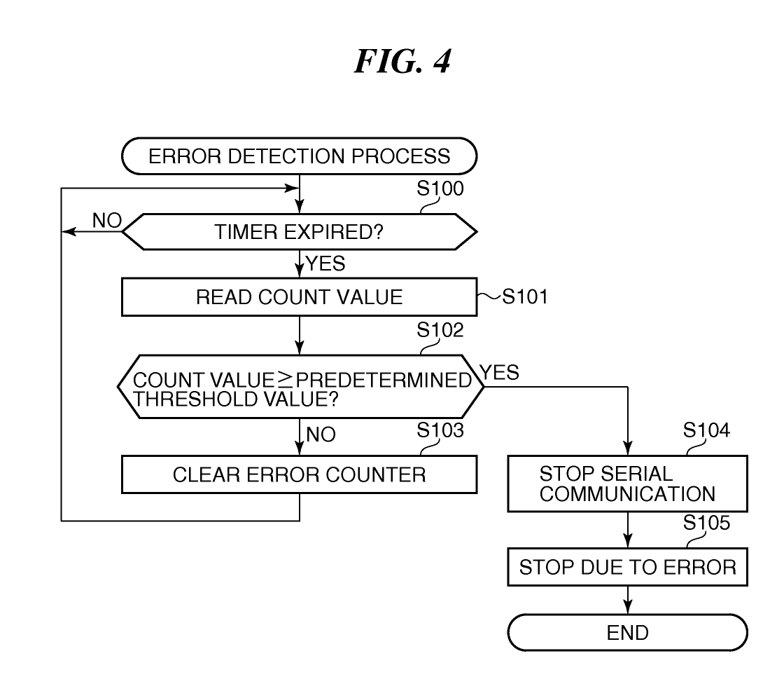

FIG. 4 is a flowchart showing an error detection process of a comparative example that is different from this embodiment. It is described here for comparison with the error detection of this embodiment.

In FIG. 4, when a timer expired (YES in the step S100), the count value is read from the error counter (step S101) at predetermined time intervals. The count value indicates the number of occurrence of errors.

Next, it is determined whether the count value is not smaller than a predetermined threshold value (step S102).

When the count value is smaller than the predetermined threshold value (NO in the step S102), the error counter is cleared by “0” (step S103), and the process returns to the step S100.

On the other hand, when the count value is not smaller than the predetermined threshold value (YES in the step S102), it is determined that an abnormality has occurred in the image forming apparatus 200, and the serial communication is stopped (step S104).

Then, the image forming apparatus 200 displays error message on an operation unit etc. to notify a serviceman, a user, etc., the image forming apparatus 200 is stopped due to the abnormality (step S105), and the process is finished.

If the predetermined threshold value is too small, the image forming apparatus 200 will stop immediately due to momentary data corruption, which increases downtime. Since an error in the serial communication can be recovered by retransmitting data when the error is detected by an error detection function, the predetermined threshold value is usually set to some large value.

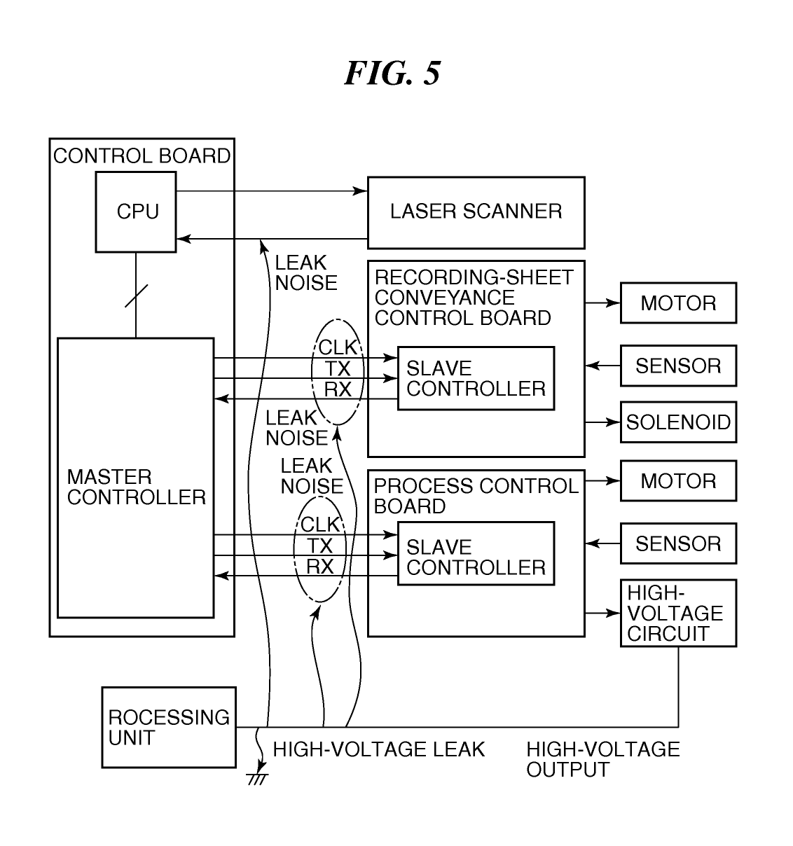

However, an abnormal condition that cannot be detected by the error detection process in FIG. 4 may occur. FIG. 5 is a view showing a state where leak noises occur in serial communication and parallel communication in the comparative example.

When the power of a high-pressure board leaks due to a certain cause and a leak noise occurs in the serial communication and parallel communication inside the apparatus as shown in FIG. 5, the error detection process shown in FIG. 4 may not detect the noise as an error.

When the leak noises occur frequently within predetermined time, the error detection process shown in FIG. 4 can detect abnormality and stop the image forming apparatus because the serial communication almost becomes an error. However, when the leak noises occur sporadically, the number of errors within the predetermined time does not exceed the threshold value, and the image forming apparatus is not stopped. When the errors in the serial communication occur sporadically, the errors may occur in the parallel communication.

As mentioned above, when an error is detected, the serial communication does not update data using the error data. However, since the parallel signal does not have such a function, the error data is transmitted to a controlled object as-is. That is, the noise resistance to leak noise of the parallel signal is lower than that of the serial signal.

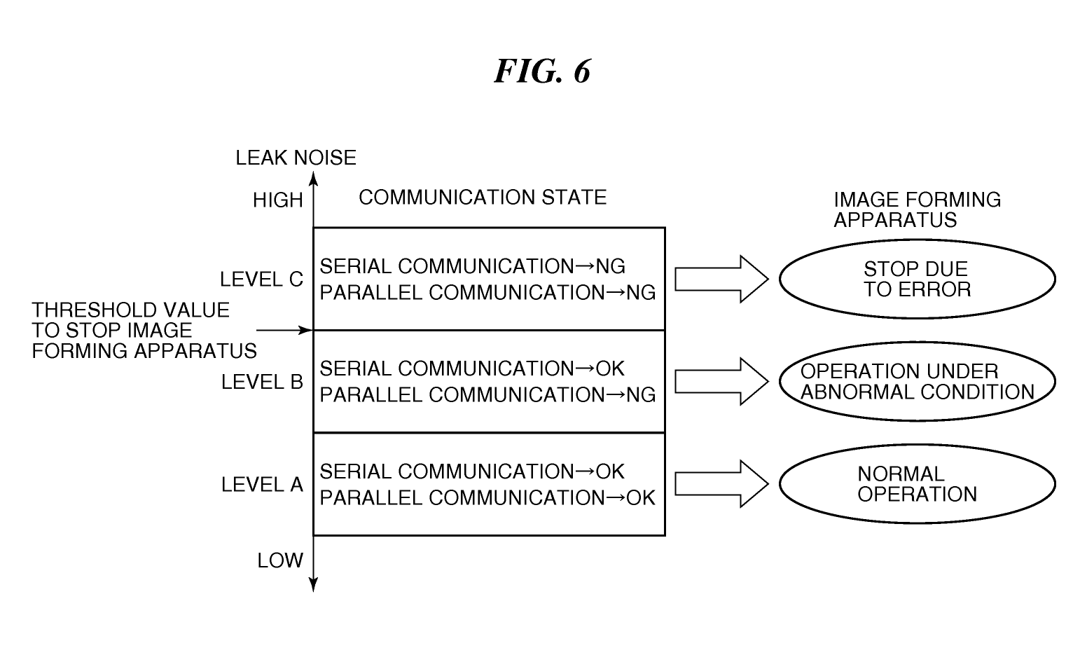

FIG. 6 is a view showing communication states and states of the image forming apparatus 200 corresponding to occurrence levels of the leak noise in the comparative example. In FIG. 6, the apparatus normally operates in a level A in which the leak-noise does not occur or the leak-noise level is low because there are no problems in the serial communication and parallel communication in the level A.

Conversely, the apparatus stops the operation due to the apparatus error in a level C in which the leak-noise level is high because the error of serial communication exceeds the stopping threshold value the apparatus.

However, the serial communication does not have a problem but the parallel communication has a problem in a level B in which the leak-noise level does not reach the stopping threshold value. For example, when a laser beam detection signal that returns to the CPU 101 from the laser scanner 106 contains a noise, a continuous operation of the image forming apparatus disturbs a writing start position of an image, and an abnormal image will be outputted.

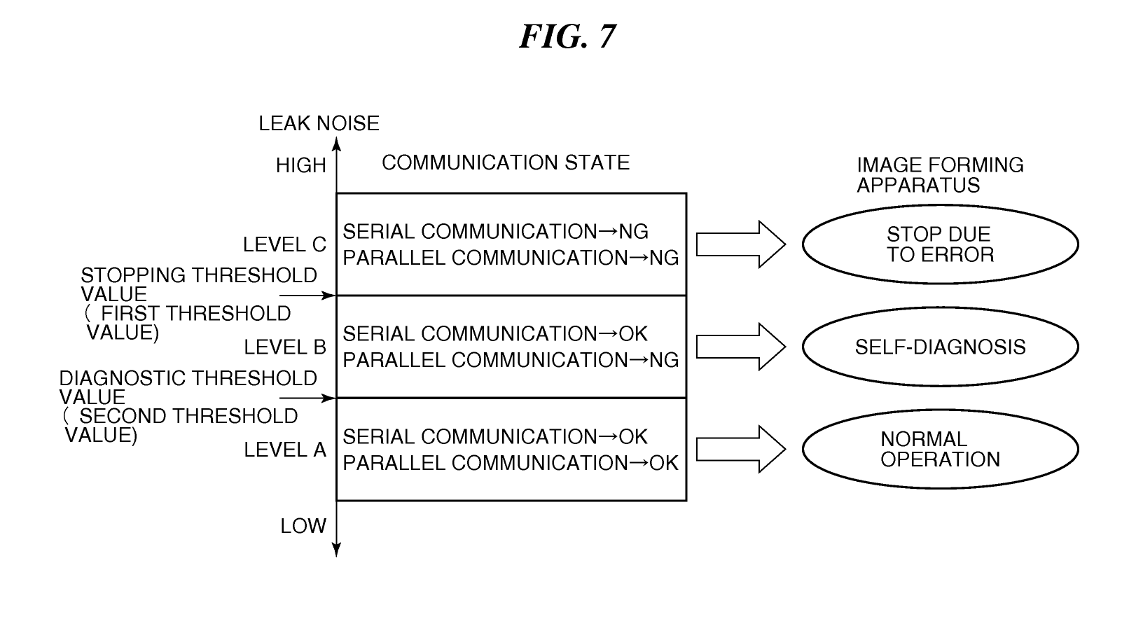

Thus, the embodiment establishes a first threshold value (a stopping threshold value) that is used to stop the image forming apparatus 200 and a second threshold value (a diagnostic threshold value) that is lower than the first threshold value and for diagnosing itself to determine whether abnormality has occurred. FIG. 7 is a view showing the first threshold value and the second threshold value.

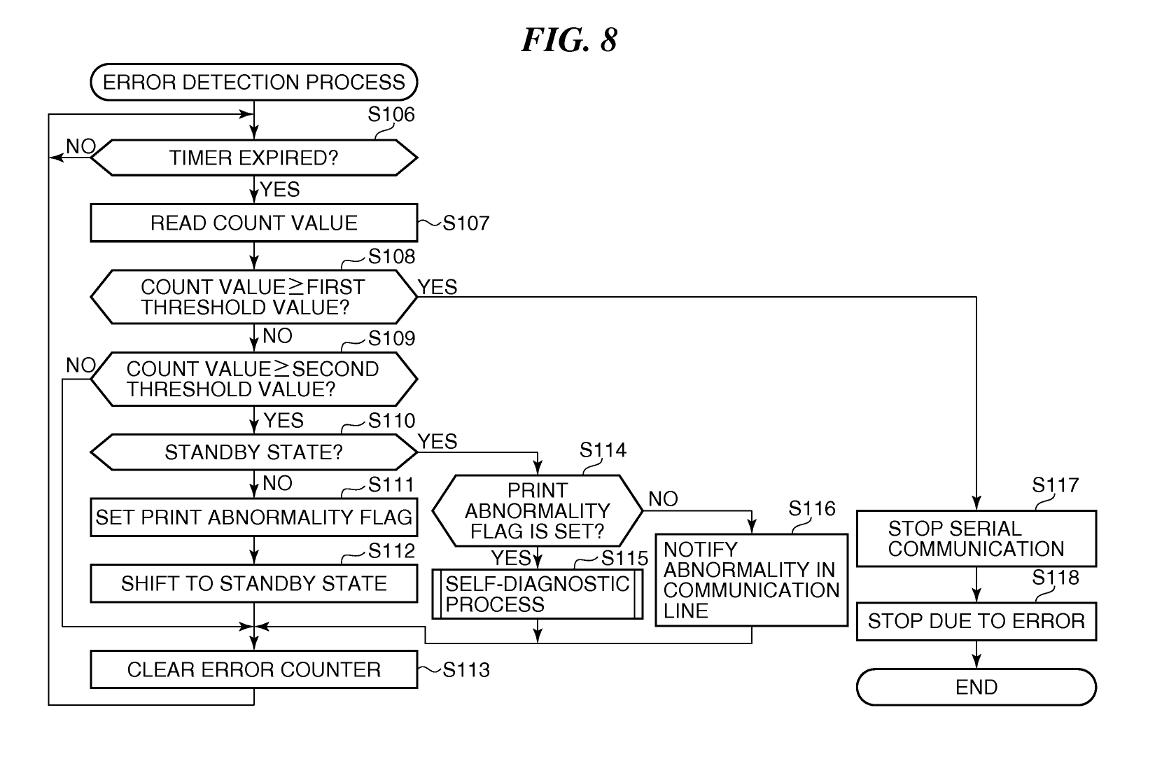

FIG. 8 is a flowchart showing an error detection process according to the embodiment executed by the CPU 101 in FIG. 2.

When a predetermined timer expired (YES in step S106), the CPU 101 reads the count value from the error counter 105 (step S107). The count value indicates the number of occurrence of errors at predetermined time interval.

Next, the CPU 101 determines whether the read count value is not smaller than the first threshold value (step S108).

When the count value is not smaller than the first threshold value (YES in the step S108), the CPU 101 determines that certain abnormality has occurred in the image forming apparatus 200, and stops the serial communication (step S117). The CPU 101 displays an error message in order to notify a serviceman, a user, etc. of the error of the image forming apparatus 200, and stops the image forming apparatus 200 (step S118). The process in the step S118 corresponds to a process performed by a first stop unit, which stops a process concerning image formation when the number of error occurrence counted in predetermined time interval is not less than the first threshold value.

On the other hand, when the count value is smaller than the first threshold value (NO in the step S108), the CPU 101 determine whether the count value is not smaller than the second threshold value (step S109).

When the count value is smaller than the second threshold value (NO in the step S109), the CPU 101 clears the error counter by “0” (step S113), and returns the process to the step S106.

On the other hand, when the count value is not smaller than the second threshold value (YES in the step S109), the CPU 101 determines whether the image forming apparatus 200 is in a standby state (step S110). The standby state is an idle state in which a job (for example, a printing process) concerning the image formation is not performed.

When the image forming apparatus 200 is not in the standby state (NO in the step S110), the CPU 101 determines that the abnormality occurs in printing, and sets a print abnormality flag (step S111). Then, the CPU 101 once interrupts the job, makes the apparatus shift to the standby state (step S112), and proceeds with the process to the step S113.

When the image forming apparatus 200 is in the standby state (YES in the step S110) on the other hand, the CPU 101 determines whether the print abnormality flag is set (step S114).

When the print abnormality flag is not set (NO in the step S114), it is guessed that an error has occurred in the serial communication in the standby state in which the operation concerning image formation is not performed. That is, it is guessed that an error has occurred due to abnormality in the communication line instead of leak noise. Accordingly, the CPU 101 displays an error message that indicates the abnormality in the communication line on an operation unit (step S116), and proceeds with the process to the step S113. That is, when the number of error occurrence is not smaller than the second threshold value and is smaller than the first threshold value, and when the number of error occurrence is counted under the state where the processing unit does not perform the process concerning the image formation, the abnormality in the communication line is notified.

On the other hand, when the print abnormality flag is set (YES in the step S114), the cause of error cannot be specified to the abnormality in the communication line. Accordingly, the CPU 101 performs the self-diagnostic process to diagnose the image forming apparatus 200 by itself (step S115), and proceeds with the process to the step S113.

The determination about the abnormality in the communication line will be described here. As mentioned above, when an error of serial communication has occurred due to the leak noise of high-voltage current, the error is detected during the printing operation in which the high-voltage current is outputted, but the error is not detected in the standby state in which the high-voltage current is stopped.

When the error of serial communication is detected in both of the print state and the standby state, the abnormality that does not depend on the operating state of the controlled object of the image forming apparatus 200 has occurred.

Accordingly, the most possible error is abnormality in the serial communication line. Specifically, a loose connection of the serial communication line is considered. For example, a case where a connection of a pin of connector is unstable because the connector of communication line is inserted in half way or is inserted slantingly can be considered.

When the count value increases regardless of the operating state of the image forming apparatus 200, abnormality in the communication line can be presumed. Accordingly, when such abnormality occurs, a message showing the occurrence of abnormality in the communication line is displayed on the operation unit to urge a serviceman to improve.

However, when the count value increases but does not reach the first threshold value (the level A), the abnormality occurs in the serial communication line but there is low possibility of occurrence of abnormality in the parallel signal line. Accordingly, the improvement of the serial communication line is urged and the apparatus continues the operation. That is, the apparatus keeps the state in which the printing process can be continued.

The process in the step S115 in FIG. 8 is executed when the print abnormality flag is set. The count value increases in the printing operation and does not increase in the standby state. That is, the count value increases when a certain specific controlled object operates.

Accordingly, the self-diagnostic process surveys the count value while operating every controlled object that operates in the printing process, one by one.

According to the process in FIG. 8, when the number of error occurrence counted in the predetermined unit time is not smaller than the predetermined first threshold value (YES in the step S108), the CPU 101 stops the process concerning the image formation (the step S118).

Moreover, when the number of error occurrence is not smaller than the second threshold value and is smaller than the first threshold value, the CPU 101 diagnoses the processing units by making processing units perform a predetermined process among the processes concerning the image formation by turn so as to determine whether abnormality exists or not in the processing units (step S115).

As a result, when abnormality occurs in the image forming apparatus, the image forming apparatus does not continue the operation, detects the abnormality, and diagnoses the cause by itself.

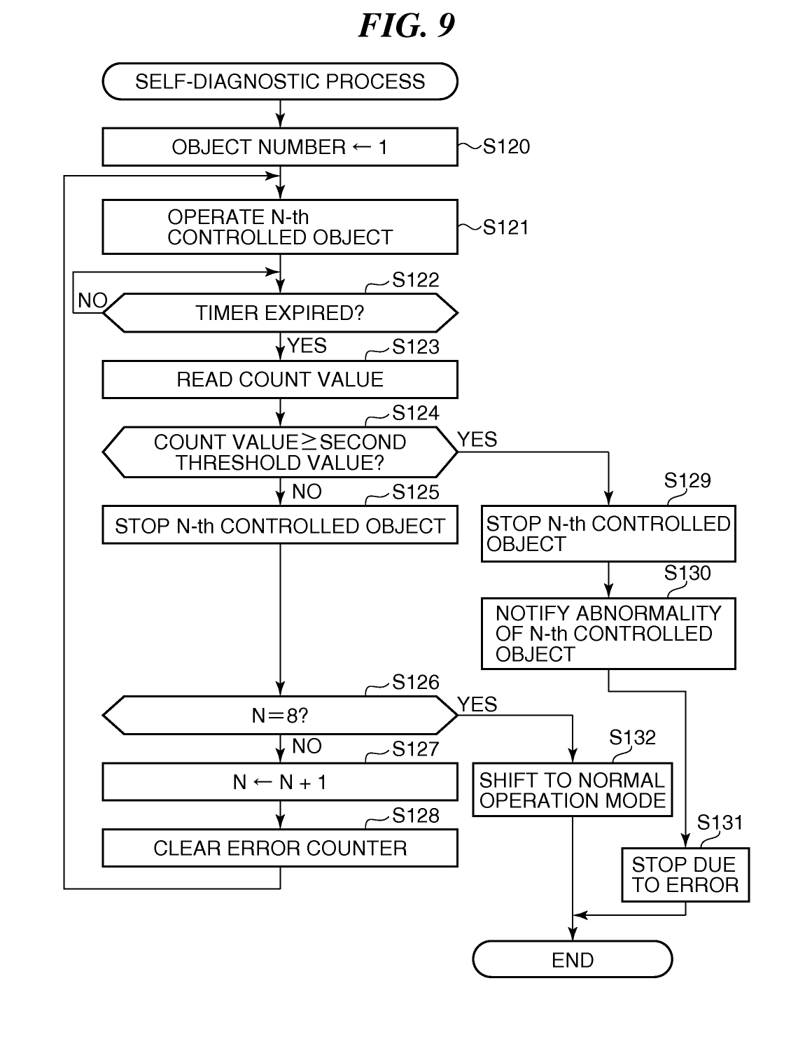

FIG. 9 is a flowchart showing the self-diagnostic process executed in the step S115 in FIG. 8.

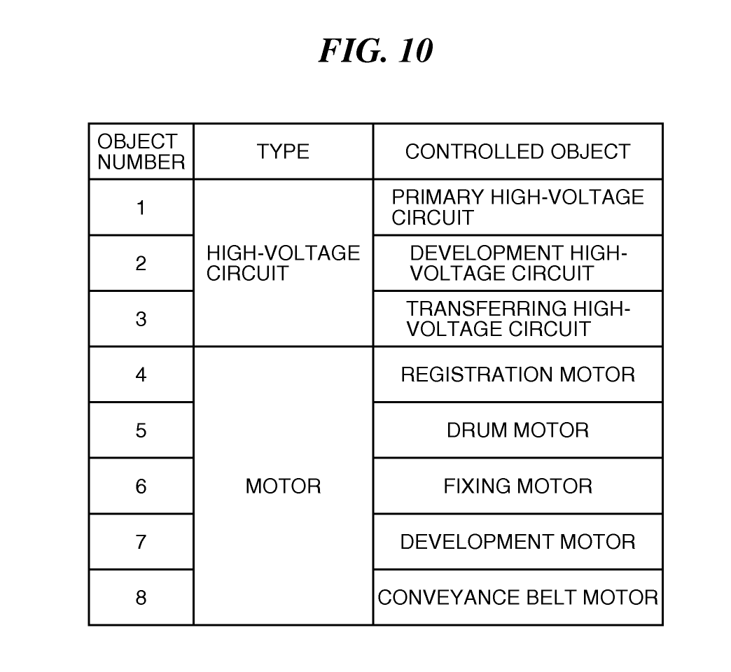

FIG. 10 is a view showing the numbers and types of the controlled objects used in the self-diagnostic process shown in FIG. 9.

FIG. 10 shows a list of controlled objects including the high-voltage circuits and motors concerning the image formation as examples to be checked. In addition, fans, solenoids, etc. may be listed as the objects. These controlled objects are selected to specify a cause of abnormality in the process concerning the image formation executed by the processing units.

In FIG. 9, the object number N is reset by “1” (step S120), and the controlled object of the target number N shown in FIG. 10 is operated (step S121). That is, the master controller 102 transmits a control signal for operating the controlled object to the slave controller 111 of the process control board 112 using the send data TX. In the embodiment, a primary high-voltage circuit is operated as the object number 1.

The CPU 101 is supervising the error count in the serial communication. Then, when the timer expired (YES in step S122), the CPU 101 reads the count value from the error counter 105 (step S123).

Next, the CPU 101 determines whether the count value is not smaller than the second threshold value (step S124). When the count value is smaller than the second threshold value (NO in the step S124), the CPU 101 stops the N-th controlled object (step S125), and determine whether the object number N equals 8 (step S126).

This determines whether all the controlled objects have been checked. When the object number N equals 8 (YES in the step S126), it is determined that the self-diagnostic process did not detect abnormality, and the CPU 101 shifts the apparatus to the normal operation mode (step S132, the apparatus control step), and finishes the process. The image forming apparatus 200 is controlled to operate as-is in the step S132.

On the other hand, when the object number N does not equal 8 (NO in the step S126), the CPU 101 increments the object number N by 1 (step S127), clears the error counter by 0 (step S128), and proceeds with the process to the step S121.

When the count value is not smaller than the second threshold value (YES in the step S124), the CPU 101 stops the N-th controlled object (step S129). Then, the CPU 101 displays a message, which shows the abnormality of the N-th controlled object operated and urges an inspection thereof, on the operation unit in order to notify the abnormality of the N-th controlled object (step S130). Then, the CPU 101 stops the image forming apparatus 200 due to the error (step S131, the apparatus control step), and finishes this process.

Thus, since possibility that an error occurs also in the parallel communication is high when the error in the serial communication is caused by a controlled object, the image forming apparatus is stopped. On the other hand, when the error in the serial communication is caused by a different factor from a controlled object, the image forming apparatus shifts to the normal operation mode that allows the normal operation. Accordingly, the interrupted job is resumed when the job was interrupted in the step S111.

As described above, the embodiment establishes the second threshold value in the lower range than the first threshold value that is compared with the number of communication errors in the serial signal to determine whether to stop the image forming apparatus 200 in which the serial signals and the parallel signals are contained.

Then, when the number of errors in the serial communication is larger than the first threshold value, the image forming apparatus 200 is stopped. When the number of errors in the serial communication is smaller than the second threshold value, the image forming apparatus 200 continues operating. When the number of errors in the serial communication is larger than the second threshold value and is smaller than the first threshold value, the abnormal object is specified, and it is determined whether to operate or to stop the image forming apparatus according to the specified abnormal object.

Such control prevents the operation of the image forming apparatus in the state where an error occurs in the parallel communication. Then, when the error occurs only in the serial communication and the error measures to serial communication overcome the communication error, the image forming apparatus is allowed continuing the operation. That is, the embodiment can avoid stopping the image forming apparatus more than needed, while preventing the operation of the image forming apparatus in the abnormal state.

Next, a second embodiment of the present invention will be described. A mechanical configuration of an image forming apparatus 200 in the second embodiment is the same as the configuration shown in FIG. 1.

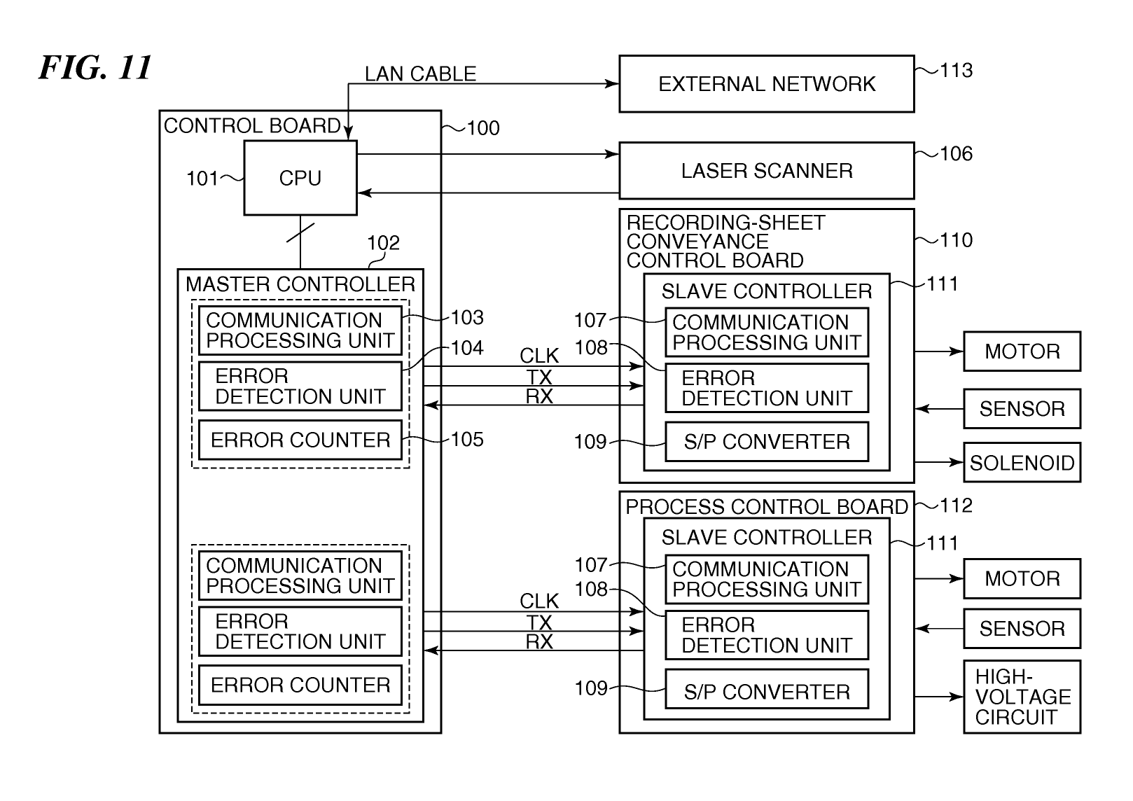

FIG. 11 is a view showing an electrical configuration of the image forming apparatus 200 according to the second embodiment.

The configuration shown in FIG. 11 is different from the first embodiment in that the image forming apparatus 200 is connected to an external network 113 via a LAN cable. The other configuration is identical to the first embodiment, and the descriptions thereof are omitted.

Wire LAN is shown in FIG. 11 as a connecting unit to the external network. However, the connection unit is not limited to this. Since the connection unit may have a function only to disseminate information about the image forming apparatus 200 to external units, configurations using wireless LAN, a telephone line, etc. may be used.

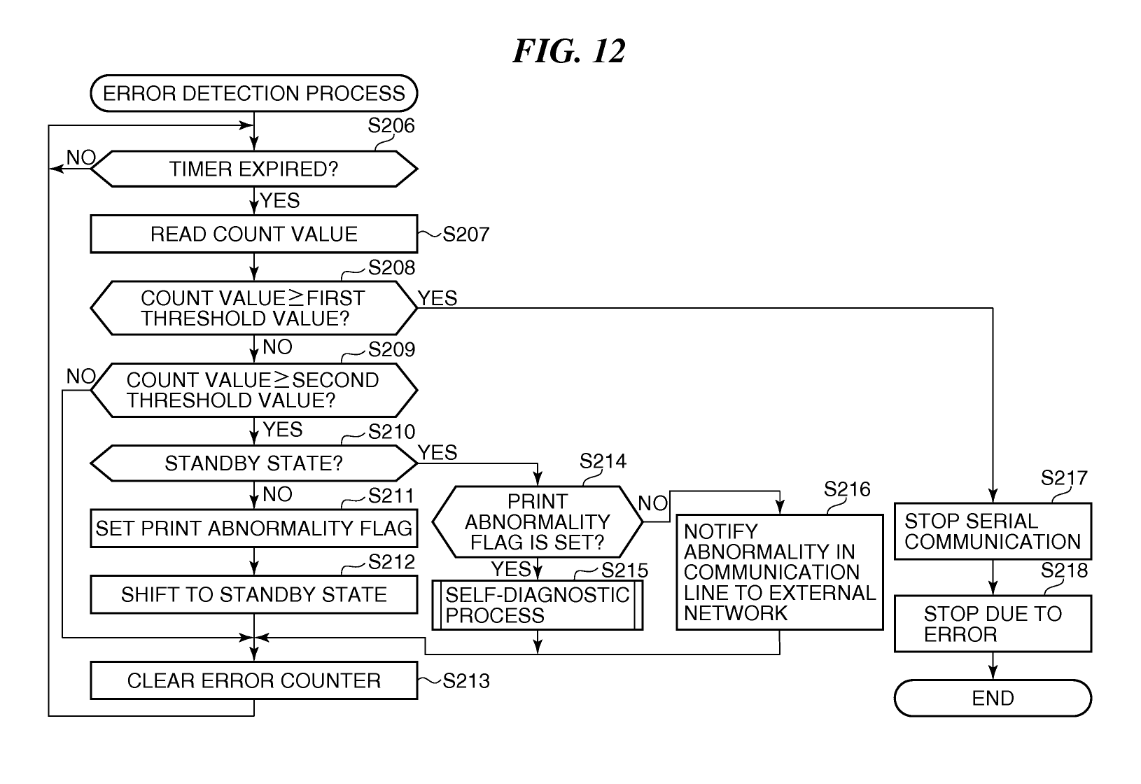

FIG. 12 is a flowchart showing an error detection process executed by the CPU 101 in FIG. 11.

In FIG. 12, when a timer expired (YES in the step S206), the CPU 101 reads the count value from the error counter (step S207) in order to read the count value from the error counter at predetermined time intervals. The count value indicates the number of occurrence of errors.

Next, the CPU 101 determines whether the count value in the predetermined time is not smaller than the first threshold value (step S208).

When the count value is not smaller than the first threshold value (YES in the step S208), the CPU 101 determines that certain abnormality has occurred in the image forming apparatus 200, and stops the serial communication (step S217). The CPU 101 displays the abnormality of the image forming apparatus 200 on an operation unit etc. as an error message to notify a serviceman, a user, etc., and stops the image forming apparatus 200 due to the error (step S218).

On the other hand, when the count value is smaller than the first threshold value (NO in the step S208), the CPU 101 determine whether the count value is not smaller than the second threshold value (step S209).

When the count value is smaller than the second threshold value (NO in the step S209), the CPU 101 clears the error counter by “0” (step S213), and returns the process to the step S206.

On the other hand, when the count value is not smaller than the second threshold value (YES in the step S209), the CPU 101 determines whether the image forming apparatus 200 is in a standby state (step S210). The standby state is an idle state in which a job (for example, a printing process) concerning the image formation is not performed.

When the image forming apparatus 200 is not in the standby state (NO in the step S210), the CPU 101 determines that the abnormality occurs in the printing process, and sets a print abnormality flag (step S211). Then, the CPU 101 once interrupts the job, makes the apparatus shift to the standby state (step S212), and proceeds with the process to the step S213.

When the image forming apparatus 200 is in the standby state (YES in the step S210) on the other hand, the CPU 101 determines whether the print abnormality flag is set (step S214).

When the print abnormality flag is not set (NO in the step S214), it is guessed that abnormality has occurred not only in the print operation but also in the serial communication. Accordingly, the CPU 101 notifies the abnormality in the communication line to a personal computer etc. that is used by a person (a serviceman, for example) who bears the maintenance of the image forming apparatus 200 via the external network 113 (step S216), and proceeds with the process to the step S213. The process in the step S216 corresponds to the notification unit that notifies the abnormality of the communication line for communicating with an external unit.

This enables a serviceman to know the abnormality of the apparatus even at a distant position. Since it is specified that the abnormality occurs in the communication line, the time required for fixing the trouble at the site can be shortened. Since the serviceman can prepare the replacement parts of the communication line, etc. before visiting the site, the unnecessary time of returning to taking replacement parts again after specifying the cause is reduced.

On the other hand, when the print abnormality flag is set (YES in the step S214), the CPU 101 performs the self-diagnostic process shown in FIG. 9 (step S215), and proceeds with the process to the step S213.

As described above, the apparatus notifies a serviceman of the information about the detected abnormality via the external network, and the serviceman can know the abnormality promptly. Since the part of abnormality has been narrowed, the time required for fixing the trouble can be shortened. When the serviceman prepares the replacement parts of the abnormal part beforehand, the unnecessary time of returning to taking replacement parts after specifying the abnormal part is reduced.

In the above-mentioned embodiments, as shown in FIG. 3, the master controller 102 transmits a set of a start bit, a command, a data block, a parity bit, and a stop bit to the slave controller 111 using the send data TX at predetermined intervals. However, the present invention may use a method of communicating only when control is required. In such a method, when an error is detected, it is necessary to retry communication.

Although the above-mentioned embodiments control the timing at which the count value is read from the error counter using the timer, the timing at which the count value is read may be controlled by other methods. For example, the master controller 102 may control the count value based on the number of transmission of the start bit using the send data TX. Similarly, the timing may be controlled using the communication clock signal CLK, the receive-data RX, etc.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-264633, filed on Dec. 2, 2011, which is hereby incorporated by reference herein in its entirety.

What is claimed is:

1. An image forming apparatus that has one or more processing units configured to perform processes concerning image formation and a control unit configured to control the processing units by communicating with the processing units via serial communication or parallel communication, comprising:
a detection unit configured to detect errors in the serial communication;
a count unit configured to count the number of errors detected by said detection unit;
a specifying unit configured to specify cause of the detected errors when the count value showing the number of errors counted by said count unit is not smaller than a predetermined diagnostic threshold value; and
a general control unit configured to control the image forming apparatus to operate or stop the image forming apparatus based on the cause specified by said specifying unit.

2. The image forming apparatus according to claim 1, wherein said general control unit controls the image forming apparatus so as to stop the image forming apparatus when the count value is not smaller than a stopping threshold value that is larger than the diagnostic threshold value.

3. The image forming apparatus according to claim 1, wherein said specifying unit operates every controlled object included in each of the processing units one by one, and specifies cause of errors when the number of errors detected during the operation of the controlled object concerned is not smaller than the diagnostic threshold value.

4. A control method for an image forming apparatus that is provided with one or more processing units for performing processes concerning image formation and a control unit for controlling the processing units by communicating with the processing units via serial communication or parallel communication, the control method comprising:
detecting an error in the serial communication;
counting the number of errors detected by said detecting;
specifying cause of the detected errors when the count value showing the number of errors counted by said counting is not smaller than a predetermined diagnostic threshold value; and
controlling the image forming apparatus to operate or stop the image forming apparatus based on the cause specified by said specifying.

5. A non-transitory computer-readable storage medium storing a control program causing a computer to execute a control method for an image forming apparatus that is provided with one or more processing units for performing processes concerning image formation and a control unit for controlling the processing units by communicating with the processing units via serial communication or parallel communication, the control method comprising:
detecting an error in the serial communication;
counting the number of errors detected by said detecting;
specifying cause of the detected errors when the count value showing the number of errors counted by said counting is not smaller than a predetermined diagnostic threshold value; and
controlling the image forming apparatus to operate or stop the image forming apparatus based on the cause specified by said specifying.
